(19) United States
(12) Patent Application Publication
(10) Pub. No.: US 2024/0008519 A1
(43) Pub. Date: Jan. 11, 2024

(54) PROTEIN COMPOSITION FOR HOT FOODS OR BEVERAGES

(71) Applicant: NZ PURE HEALTH SYSTEMS LIMITED, Albany Auckland (NZ)

(72) Inventors: Christopher Bernhard Heinrich BUHMANN, Takapuna Auckland (NZ); Keith Patrick BOWDEN, Panmure Auckland (NZ)

(73) Assignee: NZ PURE HEALTH SYSTEMS LIMITED, Albany Auckland (NZ)

(21) Appl. No.: 18/252,397

(22) PCT Filed: Nov. 10, 2021
(86) PCT No.: PCT/NZ2021/050198

§ 371 Date: May 10, 2023

(30) Foreign Application Priority Data
Nov. 10, 2020 (NZ) 769790

(51) Int. Cl. A23L 33/19; A23L 27/00; A23L 33/175; A23L 2/66; A23L 23/00; A23L 2/56

(52) U.S. Cl. CPC A23L 33/19; A23L 27/84; A23L 33/175; A23L 2/66; A23L 23/00; A23L 2/56

(57) ABSTRACT

A high protein composition that is rapidly soluble or dispersible in hot foods or beverages (having a temperature of 60° C. or more), while maintaining the palatability of the food or beverage. The composition comprises at least one hydrolysed protein component in an amount of between 80-85% w/w and one or more masking agents in a total amount of between 15-20% w/w. When added to the food or beverage, the composition enriches the protein content without adversely affect the taste or texture of the food or beverage.

### FIELD OF THE INVENTION

The present invention relates to a protein supplement or protein composition comprising a high protein content, that is highly and rapidly soluble or dispersible in liquid foods or beverages, even at higher temperatures, while maintaining the palatability of the food or beverage.

### BACKGROUND

Protein compositions and protein supplements are widely available and are consumed by a wide variety of people for different purposes. For example, they are popular among health-conscious individuals, including athletes and others who want to increase muscle mass. They may also be consumed by individuals who, for one reason or another, have a diet that is lacking in protein, and therefore essential amino acids. They may be consumed as part of a dietary or nutritional plan that requires a higher protein diet. Protein supplements are often recommended for people who need to increase muscle health and mass, for example, the elderly and post-surgical patients. Protein supplements are also beneficial for those with less efficient digestive systems, such as the elderly, where it may be more difficult to digest protein from food such as meat.

There are two main categories or sources of protein—animal and plant based. Animal-based proteins include whey (from dairy), casein (from dairy), eggs, and meat such as beef, chicken and fish. Plant-based proteins include soy, pea, brown rice, chickpeas and others. The main difference between animal and plant proteins is their amino acid profile. Most animal proteins are complete proteins, meaning they contain all 9 of the essential amino acids (EAAs). Most plant proteins are considered incomplete proteins, meaning they are missing at least one essential amino acid.

Whey proteins, derived from milk, are very popular because they are a complete protein supplement, containing all of the essential amino acids. They also comprise a high amount of Branched Chain Amino Acids (BCCAs) which are a subset of essential amino acids that support muscle health and growth.

Protein compositions and supplements, including whey proteins, are currently available in a range of product formats such as snack bars, pills, capsules, powders, shakes and drinks.

Protein powder supplements are often intended to be mixed with fluids or foods prior to consumption. However, protein powders, especially hydrolysed protein powders, are notorious for their unpleasant taste. Sweeteners and other flavouring agents can be used to mask the unpleasant taste, but these are often ineffective, or a large quantity of sweeteners or other additives are required in order to neutralise the bitter taste of the protein. In addition, many consumers of protein powders are health conscious and do not want to consume a lot of additional sugars, artificial sweeteners or other additives.

Another problem with proteins for use in liquid foods and beverages is that they must possess a high solubility in the system. However, solubility of proteins is often difficult to achieve. Although some protein powders are soluble in certain food systems, a true solution is rarely obtained in practice. The solubility of proteins depends on a number of intrinsic and extrinsic factors including amino acid composition and sequence, molecular weight, and conformation and content of polar and nonpolar groups in amino acids, as well as environmental factors: ionic strength, type of solvent, pH, temperature, and processing conditions.

In terms of temperature, solubility of protein powders generally decreases significantly as temperature increases. For example, it is very difficult, if not impossible, to fully dissolve protein powders in hot liquid foods or beverages. The protein powder will generally sit on top of the hot liquid or coagulate, making the food or beverage unappetising or unappealing. This is a problem the prior art has been unable to adequately resolve.

It is known that hydrolysing proteins increases their solubility to some extent, however, as noted above, hydrolysis also adversely affects taste. Hydrolysed proteins have an extremely bitter taste which imposes a practical limit on the amount of hydrolysed protein that can be used in a food or beverage product, and consequently the amount of beneficial protein the product is able to deliver to the consumer. To produce a protein composition or supplement with a high protein content, it is necessary to mask the bitter taste by use of various agents, such as sweeteners and flavouring additives. However, it is often difficult and even impossible to completely mask the taste to a satisfactory extent for some applications.

Thus, a protein composition or protein supplement comprising a high protein content that is highly and rapidly soluble or dispersible in liquid foods or beverages, even at higher temperatures, while remaining palatable, is desirable for many applications.

It is an object of the present invention to provide an improved protein composition or protein supplement, that overcomes the disadvantages of the prior art, or at least provides the public with a useful choice.

### STATEMENTS OF THE INVENTION

According to a first aspect of the invention, there is provided a protein composition with a high protein content, capable of rapidly dissolving or dispersing in a food or beverage, including a food or beverage having a temperature of 60° C. or more, wherein the composition comprises at least one hydrolysed protein component and at least one masking agent, and when added to the food or beverage, the composition does not adversely affect the palatability of the food or beverage.

Preferably the protein composition is a dried composition comprising at least one type of hydrolysed protein in an amount of between about 80-85% w/w, and one or more masking agents in a total amount of between about 15-20% w/w.

More preferably the composition comprises between 81-84% w/w of hydrolysed protein, and between 16-19% w/w masking agent(s).

Most preferably the composition comprises 83% w/w hydrolysed protein and 17% w/w masking agent(s).

Preferably, the hydrolysed protein is hydrolysed whey protein. A particularly preferred hydrolysed whey protein has a degree of hydrolysis of between about 30-40% and a typical composition of between about 80-90% protein on a dry basis. Preferably the hydrolysed whey protein comprises at least 20% BCAAs.

Preferably, the masking agent comprises one or more ingredients selected from the group comprising dextrins, maltodextrin, cyclodextrins, cellodextrins, icodextrin, carrageenans, locust bean gum, oat gum, guar gum, tragacanth, gum Arabic, xanthan gum, karaya gum, tara gum, gellan gum, and gum ghatti.

More preferably, the masking agent contains at least a combination of maltodextrin and gum Arabic. Preferably, the masking agent or the composition includes at least one flavouring additive.

In a preferred embodiment of the invention, the masking agent is a dried composition comprising a combination of three ingredients, namely about 55-65% maltodextrin, 15-25% gum Arabic, and about 15-25% of a flavouring component.

Any food flavouring additive known in the art may be used depending on the desired flavour profile and provided it does not significantly alter the solubility or dispersibility profile of the protein composition in the food or beverage.

Preferably, the protein composition is a dried composition in the form of a powder. Alternatively, it could be in the form of a flowable solid such as granules or tablets such as effervescent tablets, or crystallised form or other type of dry particle preparation. Other product formats may also be possible including pastes, gels or concentrates for dilution in liquids. Such compositions could be formulated with additional additives or excipients known in the art as required, including dispersing agents, solubility agents, stabilisers, emulsifiers, preservatives etc.

Preferably the composition is formulated to provide a relatively high daily dose of protein in one serving, for example, once the composition is added to the food or beverage of choice, it will deliver at least 60 g of protein to the consumer. This can be varied according to particular applications, for example, to produce compositions that meet specific medical or nutritional requirements.

According to a second aspect of the invention, there is provided a high protein composition capable of rapidly dissolving or dispersing in a food or beverage, including a food or beverage having a temperature of 60° C. or more, wherein the composition comprises hydrolysed whey protein in an amount of between about 80-85% w/w, and a masking agent in an amount of between about 15-20% w/w, wherein the masking agent comprises a combination of maltodextrin, gum Arabic and a flavouring component.

Preferably the masking agent comprises maltodextrin in an amount of between about 8.25%-13% w/w, gum Arabic in an amount of between about 2.25-5% w/w and the flavouring component in an amount of between about 2.25-5% w/w.

In a particularly preferred embodiment of the invention, the composition comprises hydrolysed whey protein in an amount of 83% w/w, and a masking agent in an amount of about 17% w/w, wherein the masking agent comprises maltodextrin in an amount of between about 9.35-11.05 w/w, gum Arabic in an amount of between about 2.55-3.4% w/w and the flavouring component in an amount of between about 2.55-3.4% w/w.

Importantly, the composition does not comprise any added sugars or other artificial sweeteners.

According to a third aspect of the invention, there is provided a food or beverage, wherein the food or beverage comprises a protein composition, as described herein, dissolved or dispersed therein. Preferably the food or beverage is a food or beverage having a temperature of 60° C. or more. For example, the food is generally liquid in nature, for example, a hot soup, broth, pureed vegetables, gravy or sauce, or the beverage may be any hot liquid beverage such as hot water, tea, coffee, hot chocolate etc.

### DESCRIPTION

Further aspects and advantages of the present invention will become apparent from the following description which is given by way of example only and with reference to the accompanying examples.

The present invention generally relates to a protein composition or protein supplement comprising a high protein content that is highly and rapidly soluble or dispersible in foods or beverages, even at hot temperatures, while maintaining the palatability of the food or beverage in terms of appearance, odour, taste and texture. The protein composition of the invention may be used for a variety of purposes including as a sports nutrition supplement, a meal replacement, a protein supplement, a dietary supplement, or a functional food or beverage.

In the context of the compositions of the invention, the reference to “high protein content” or “high protein composition” means a composition comprising at least 60% of protein on a dry basis.

In the context of the compositions of the invention, the reference to “rapidly dissolving or dispersing” means that it takes about 2-10 seconds for a dried composition to substantially dissolve or disperse through the food or beverage.

The present invention comprises a composition that has a specific combination and ratio of hydrolysed protein and masking agent(s) that is capable of rapidly dissolving or dispersing in a beverage or a food (generally of a liquid nature), even at hot temperatures, that is, temperatures above 60° C. Contrary to protein compositions or protein supplements known in the art, the compositions of the invention generally dissolve or disperse in the food or beverage, within about 2-10 seconds, even at hot temperatures. The inventors have surprisingly found that the compositions of the invention do not coagulate or remain insoluble or difficult to mix with hot foods or beverages, as is the case with protein compositions or protein supplements known in the art.

Despite the extremely bitter taste of the hydrolysed protein in the composition, the specific combination and ratio of the hydrolysed protein and masking agent(s) provides a composition that does not adversely affect the palatability of the food or beverage. That is, the bitter taste of the hydrolysed protein is effectively neutralised by the masking agent(s).

In preferred embodiments of the invention, the hydrolysed protein component is essentially free from caseinate. Typically, this is a hydrolysed whey protein derived from mammalian milk, typically cow's milk, however other mammalian milks could be used, for example goats' milk, sheep milk or any other mammalian milk. Alternatively, whey protein may be prepared by recombinant DNA technology, using molecular biology techniques known in the art. The hydrolysed whey protein may be prepared by chemical or enzyme hydrolysis methods known in the art. Hydrolysed whey protein is preferred because it is an extremely pure protein that delivers a complete range of essential amino acids, including a high amount of beneficial branched chain amino acids (BCAAs).

In a preferred embodiment of the invention, the hydrolysed whey protein has a degree of hydrolysis of between about 30-40% and a typical composition of between about 80-90% protein on a dry basis. Preferably the hydrolysed whey protein comprises at least 20% BCAAs.

A particularly preferred hydrolysed whey protein has a degree of hydrolysis of 39%, a TNx6.76 protein composition of 82.3% and a protein composition on a dry basis of 86%. The amount of BCAAs is about 23%. The molecular weight distribution of the product includes a majority of peptides and free amino acids with molecular weights of between 100-1000 Da.

A combination of different types of hydrolysed proteins may be used in the invention. For example, a combination of a hydrolysed whey protein with other edible proteins such as casein, lactalbumin, serum albumin, glycomacropeptide, soy protein, rice protein, pea protein, canola protein, wheat protein, hemp protein, zein, flax protein, egg white protein, ovalbumin, or gelatin protein.

In preferred embodiments of the invention, the masking agent comprises one or more of the following: dextrins, maltodextrin, cyclodextrins, cellodextrins, icodextrin, carrageenans, locust bean gum, oat gum, guar gum, tragacanth, gum Arabic, xanthan gum, karaya gum, tara gum, gellan gum, and gum ghatti.

In a preferred embodiment of the invention, the masking agent contains at least a combination of maltodextrin and gum Arabic. It may also contain one or more flavouring components. Importantly, the composition does not comprise any added sugars or other artificial sweeteners.

In a preferred embodiment of the invention, the masking agent is a combination of three ingredients, comprising about 55-65% maltodextrin or suitable alternative, 15-25% gum Arabic or suitable alternative, and about 15-25% of a flavouring component. Typically, maltodextrin is derived from partial hydrolysis of vegetable starch. The starch is usually sourced from maize or wheat. Gum Arabic is a hardened natural plant gum. It is typically extracted from Acaia senegal and Vachellia seyal trees. However, in the art, a variety of other plants species that also produce the gum are known. Any food flavouring additive known in the art may be used depending on the desired flavour profile and provided it does not alter the solubility or dispersibility profile of the protein composition in the food or beverage. This particular combination of masking agent ingredients has been surprisingly found to completely neutralise the bitter taste of the hydrolysed protein when it is included in the high protein composition in an amount of between about 15-20% w/w as discussed further below. The masking agent can be prepared by combining individual commercially available ingredients by methods known in the art.

In a preferred embodiment of the invention, the high protein composition is a dried composition comprising hydrolysed whey protein in an amount of between about 80-85% w/w, and one or more masking agents in a total amount of between about 15-20% w/w. More preferably the composition comprises between 81-84% w/w of hydrolysed protein, and between 16-19% w/w masking agent(s).

The inventors have surprisingly found that this specific combination or ratio of protein and masking agent produces an optimised product in terms of both its solubility or dispersibility in a food or beverage, and its effect on the palatability of the food or beverage, particularly in the case of hot foods or beverages where the temperature of the food or beverage is 60° C. or more. For example, increasing the protein component in the composition to above 85% w/w will negatively affect the palatability (in terms of taste and texture) of the food or beverage, while decreasing the masking agent to less than 15% w/w will negatively affect the palatability (in terms of taste and texture) of the food or beverage because the bitter taste of the protein will not be sufficiently neutralised and the protein will not rapidly dissolve or disperse in the food or beverage.

In one embodiment of the invention, the masking agent may comprise a combination of maltodextrin in an amount of between about 8.25%-13% w/w, gum Arabic in an amount of between about 2.25-5% w/w and a flavouring component in an amount of between about 2.25-5% w/w.

The inventors have found that a particularly optimal composition of the invention comprises 83% w/w hydrolysed whey protein and 17% w/w masking agent(s). In this embodiment, the masking agents are a mixture of: maltodextrin in an amount of between about 9.35-11.05% w/w, gum Arabic in an amount of between about 2.55-3.4% w/w and a flavouring component in an amount of between about 2.55-3.4% w/w.

The high protein composition is preferably formulated as a dried powdered composition. It can be manufactured by combining the separate, preferably dry, ingredients by methods known in the art. For example, the ingredients are weighed according to the recipe and blended. Other forms of the composition are possible however. For example, the composition could be formulated into a flowable solid, such as granules, or it could be formulated into tablets, such as soluble or effervescent tablets, or in crystallised form or another type of dry particle preparation, by use of methods known in the art. Other possible product formats including pastes, gels and concentrates for dilution into liquids may also be possible. Such compositions could be formulated with additional additives or excipients known in the art as required, including but not limited to dispersing agents, solubility agents, stabilisers, emulsifiers, preservatives, colouring agents, viscosity agents, turbidity agents etc.

The composition of the invention may contain additional components to enhance the palatability, consumer acceptability, and potential health benefits of the beverage. For example, the composition may contain vitamins, minerals or electrolytes or other health promoting ingredients including but not limited to antioxidants, trace elements, glucosamine, herbal supplements, plant extracts, fibre or other beneficial carbohydrates, prebiotic and/or probiotic components. However, it is important that the composition does not comprise any added sugars or other artificial sweeteners. It is also important that any additional components do not adversely affect the solubility, dispersibility, or palatability profile of the composition once added to the food or beverage.

The high protein composition of the invention is able to be rapidly dissolved or dispersed in a food (generally of a liquid nature) or a beverage, to create a palatable food or beverage with an enriched protein content. Preferably the food or beverage is a hot liquid food or beverage having a temperature of 60° C. or more. For example, the liquid food may be a hot soup, broth, pureed vegetables, gravy or sauce, or the liquid beverage may be any hot liquid beverage such as hot water, tea, coffee, hot chocolate etc.

Preferably the composition is formulated to provide a relatively high daily dose of protein in one serving, for example, once the composition is added to the food or beverage of choice, it will deliver up to 60 grams of additional protein to the consumer. This can be varied according to particular applications, for example, to produce compositions that meet specific medical or nutritional requirements.

A typical nutritional analysis of a dried composition of the invention (measured as average quantity per 100 g) is as follows:

| | | |
|---|---|---|
| Energy | 1660 | KJ |
| Protein | 68.29 | g |
| Total Fat | 3.4 | g |
| Saturated Fat | 3.1 | g |
| Carbohydrate | 22.0 | g |
| Total Sugar | 2.1 | g |
| Sodium | 380 | mg |

The inventors have developed an improved protein composition or protein supplement comprising hydrolysed protein and a masking agent in a specific synergistic combination that results in a highly and rapidly soluble or dispersible formulation that can be added to a food or beverage, including a hot food or beverage, without adversely affecting the palatability of the food or beverage. The composition delivers a relatively high dose of protein so it can be consumed easily and regularly to obtain the benefits of additional protein in a diet.

### EXAMPLES

The invention will now be described further with reference to the following specific but non-limiting examples.

### Example 1—Protein Composition

A protein composition is prepared by combining the following dried ingredients in a conventional manner.

| Ingredient | Amount (% by weight) |
|---|---|
| Hydrolysed whey protein | 83 |
| Maltodextrin | 10.2% |
| Gum Arabic (E414) | 3.4% |
| Flavouring preparation(s) | 3.4% |

### Example 2—Protein Composition

A protein composition is prepared by combining the following dried ingredients in a conventional manner.

| Ingredient | Amount (% by weight) |
|---|---|
| Hydrolysed whey protein | 81 |
| Maltodextrin | 11 |
| Gum Arabic (E414) | 4 |
| Flavouring preparation(s) | 4 |

### Example 3—Protein Composition

A protein composition is prepared by combining the following dried ingredients in a conventional manner.

| Ingredient | Amount (% by weight) |
|---|---|
| Hydrolysed whey protein | 85 |
| Maltodextrin | 10 |
| Gum Arabic (E414) | 5 |

### Example 4—Protein Composition

A protein composition is prepared by combining the following dried ingredients in a conventional manner.

| Ingredient | Amount (% by weight) |
|---|---|
| Hydrolysed whey protein | 84 |
| Maltodextrin | 12 |
| Gum Arabic (E414) | 4 |

### Example 5—Preparation of Hot Beverage

A hot beverage can be prepared by adding between about 5-10 grams of the protein composition of Example 1 to about 250 ml of hot water. The protein composition rapidly dissolves or disperses into the hot water, with minimal stirring required.

### Example 6—Preparation of Hot Food

Various flavours of soups were prepared by adding between about 5-10 grams of the protein composition of Example 1 to about 350 ml of each of the hot soups. In each case the protein composition rapidly dissolved or dispersed into the soup upon stirring. The palatability of each of the soups was tested by a panel of three people, and any noticeable differences in taste or texture from the original soup were recorded. The results are shown in the table below.

| | Amount of protein | Change in | Change in |
|---|---|---|---|
| Soup flavour | composition added | Taste | Texture |
| Roast tomato | 7 grams | None detected | None detected |
| Roast pumpkin | 5 grams | None detected | None detected |
| Vegetable | 6 grams | None detected | None detected |
| Green (broccoli, | 9 grams | None detected | None detected |
| zucchini, kale) | | | |
| Potato and leek | 7 grams | None detected | None detected |
| Carrot | 8 grams | None detected | None detected |

### ADVANTAGES

The present invention provides a number of advantages, including:
Providing a protein composition or protein supplement that is able to deliver a high amount of protein to a consumer in a desirable and palatable format, in contrast to other commercially available products;
Providing a protein composition or protein supplement that is readily and rapidly soluble or dispersible in hot (generally liquid) foods or beverages;
Providing a protein composition or protein supplement that does not impart an unpleasant taste or bitter aftertaste;
Providing a protein composition or protein supplement which can be easily mixed with hot liquid foods or beverages, and consumed as a sports nutrition supplement, meal replacement, dietary supplement, functional food or beverage which provides a high amount of protein including a complete range of essential amino acids and a high amount of BCAAs.
High protein compositions having the perfect balance of solubility or dispersibility as well as palatability once mixed with a hot food or beverage.

It will of course be realized that while the foregoing has been given by way of illustrative example of this invention, all such and other modifications and variations thereto as would be apparent to persons skilled in the art are deemed to fall within the broad scope and ambit of this invention as is hereinbefore described.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e. it will be taken to mean an inclusion of not only the listed components it directly references, but also other non-specified components or elements. This rationale will also be used when the term ‘comprised’ or ‘comprising’ is used in relation to one or more steps in a method or process.

All references cited in this specification, including any patent or patent application, or any document, act, or item of knowledge, are hereby incorporated by reference. The discussion of these references states what their authors (or proponents) assert. No admission is made that any reference constitutes valid prior art; neither is any admission made as to the accuracy or pertinency of any reference. All rights to challenge the accuracy, pertinency and/or validity as prior art of any reference are hereby reserved.

1. A high protein composition, capable of rapidly dissolving or dispersing in a food or beverage having a temperature of 60° C. or more, wherein the composition comprises at least one hydrolysed protein component and at least one masking agent, and wherein the composition does not adversely affect the palatability of the food or beverage once dissolved or dispersed therein.

2. The composition of claim 1 wherein the composition comprises between about 80-85% w/w of hydrolysed protein(s).

3. The composition of claim 1, wherein the composition comprises between about 15-20% w/w of one or more masking agents.

4. The composition of claim 1, wherein the composition comprises substantially 83% w/w of hydrolysed protein(s) and substantially 17% w/w of masking agent(s).

5. The composition of claim 1, wherein the hydrolysed protein component is hydrolysed whey protein comprising between about 80-90% protein on a dry basis.

6. The composition of claim 5, wherein the hydrolysed whey protein has a degree of hydrolysis of between about 30-40%.

7. The composition of claim 5, wherein the hydrolysed whey protein comprises at least 20% branched chain amino acids (BCAAs).

8. The composition of claim 1, wherein the masking agent(s) are selected from the group comprising dextrins, maltodextrin, cyclodextrins, cellodextrins, icodextrin, carrageenans, locust bean gum, oat gum, guar gum, tragacanth, gum Arabic, xanthan gum, karaya gum, tara gum, gellan gum, and gum ghatti.

9. The composition of claim 7, wherein the masking agent(s) are a combination of maltodextrin and gum Arabic.

10. The composition of claim 1, wherein the composition comprises hydrolysed whey protein in an amount of 83% w/w, and a masking agent in an amount of about 17% w/w, wherein the masking agent comprises a mixture of maltodextrin in an amount of between about 9.35-11.05 w/w, gum Arabic in an amount of between about 2.55-3.4% w/w and a flavouring component in an amount of between about 2.55-3.4% w/w.
